(19) United States
(12) Patent Application Publication
(10) Pub. No.: US 2025/0194618 A1
(43) Pub. Date: Jun. 19, 2025

(54) SMOKER

(71) Applicant: James A. Rose, Murrysville, PA (US)

(72) Inventor: James A. Rose, Murrysville, PA (US)

(21) Appl. No.: 19/069,586

(22) Filed: Mar. 4, 2025

Related U.S. Application Data
(63) Continuation-in-part of application No. 18/206,879, filed on Jun. 7, 2023.
(60) Provisional application No. 63/349,810, filed on Jun. 7, 2022.

(51) Int. Cl. A23B 4/052; A47J 37/07

(52) U.S. Cl. CPC A23B 4/0523; A47J 37/0704; A47J 37/0754

(57) ABSTRACT

The present invention is directed to a smoker device for smoking and cooking food that has improved smoke circulation in the smoking chamber, less smoke loss from the areas outside of the exhaust pipe. The present invention also comprises an improved offset smoker device.

### CROSS-REFERENCE TO RELATED APPLICATION

This application is a Continuation-in-Part application claiming priority to U.S. Nonprovisional application Ser. No. 18/206,879, filed Jun. 7, 2023, which claims the benefit under 35 U.S.C. § 119 to U.S. Provisional Application Ser. No. 63/349,810, filed Jun. 7, 2022, each of which is incorporated by reference herein in its entirety.

### BACKGROUND OF THE INVENTION

### Field of the Invention

The present invention encompasses various improved devices to cook and/or smoke food.

### Description of Related Art

Historically, smoking has been a method of cooking meat or other foods over a fire usually with the addition of wood chips to impart a smoky flavor to the food. Nowadays it is common to smoke all sorts of meat, fish, and a wide variety of other foods. Smoking is accomplished in smokers, which are devices specifically designed to smoke foods. Additionally, foods can be smoked in hybrid smoker-grills, which are grills that are designed with smoking capabilities. Finally, foods can be smoked on regular grills (or on stovetops or in ovens) by using special equipment that converts the grill, stovetop, or oven into a smoking environment. It is generally accepted in the field that specifically designed smokers are the most effective and efficient devices for smoking foods, followed by hybrid smoker-grills and then by all other smoking devices.

Hot smoking is the process whereby meat (or any food) is slowly cooked and smoked simultaneously. In a smoker, the air temperature is increased and carefully controlled to raise the meat temperature to produce a fully cooked food product in a smoking environment. A smoker usually is an outdoor cooker that enables the smoking of food usually in a home or restaurant setting.

Some variations of the present invention fall within a sub-category of smokers known as pellet smokers. Pellet smokers are a combination of an oven and a smoker that can be used as an oven, grill, and/or smoker. Pellet smokers use pellets (usually compressed sawdust) that sit in a hopper on the side of the smoker and are fed into a firebox. The firebox is designed to cause the pellets to combust, which creates smoke and heat in the cooking chamber. Ideally, a pellet smoker has a built-in thermometer to keep the temperature stable. Pellet smokers can be designed to automatically change the airflow and the amounts of pellets being fed into the firebox to create a consistent heat.

There are several problems and concerns that exist in the field of smoking foods that the present invention addresses. First is the movement of gas within the cooking chamber. Some commercial devices rely upon the use of a fan in the cooking chamber to circulate the heat and smoke throughout the chamber. The design of the present invention does not necessitate a fan for this purpose. The present invention achieves smoke circulation without the need of any additional fans or equipment in the cooking space.

Second is the problem of containing the smoke within the chamber. A notable problem plaguing most smokers and smoker-grills on the market today is that there is a significant amount of smoke that leaks from the devices during the cooking/smoking process. This smoke pollutes the air around the smoker, making it difficult for people to stand near or around the smoker. It also makes it almost impossible to use traditional smokers indoors or in semi-enclosed settings. The present invention has eliminated a significant amount of smoke leakage from any part of the smoker except the exhaust assembly, which is the location designed for the exhaust of the heat and smoke. While the present invention will be used predominately outdoors, there are still significant advantages to decreasing the amount of smoke that leaks from various areas of the smoker.

### BRIEF SUMMARY OF THE INVENTION

The following is a summary to provide a basic understanding of one or more embodiments of the invention. This summary is not intended to identify key or critical elements nor to delineate, on its own, any scope of the particular embodiments or any scope of the claims. Its sole purpose is to present concepts in a simplified form as a prelude to the more detailed description and explanation that is presented later.

A first embodiment of the invention is an offset smoker device comprising the following: (a) a smoking chamber; (b) a firebox adjacent to and connected to the smoking chamber; (c) a firepot located within the firebox; (d) an exhaust pipe, having an inlet and an outer end, wherein the exhaust pipe connects to the smoking chamber at or near the exhaust pipe inlet and wherein at least a portion of the exhaust pipe is located inside of the firebox; and (c) an exhaust stack connected to the outer end of the exhaust pipe and extending upward. For this embodiment, the firepot heats the exhaust pipe during operation of the offset smoker device.

Another embodiment of the present invention is a smoker device for smoking or cooking food comprising the following: (a) a smoking chamber divided into a lower first sub-chamber and an upper second sub-chamber, wherein the first sub-chamber is oriented at least partially below the second sub-chamber; (b) a firepot within the first sub-chamber; (c) an exhaust assembly comprising an exhaust pipe having at least one inlet and an outer end and an exhaust stack connected to the outer end of the exhaust pipe and extending upward; and (d) a venturi configuration (or a configuration designed to implement the Venturi Effect) located within the exhaust pipe.

Another embodiment of the present invention is a smoker device comprising: (a) a smoking chamber divided into a lower first sub-chamber and an upper second sub-chamber, wherein the first sub-chamber is oriented at least partially below the second sub-chamber; (b) a firepot within the lower first sub-chamber to heat smoke; (c) a cooking surface in the upper second sub-chamber; (d) an exhaust assembly comprising an exhaust pipe having at least one inlet and an outer end and an exhaust stack connected to the outer end of the exhaust pipe and extending upward, wherein the exhaust pipe is located within the first sub-chamber above the firepot; and (c) a venturi configuration (or a configuration designed to implement the Venturi Effect) located within the exhaust assembly. For this embodiment, the smoking chamber is configured to create a circulation path for the smoke to move from the lower first sub-chamber, across the cooking surface in the second sub-chamber, back into the first sub-chamber, and into the exhaust pipe inlet.

Another embodiment of the present invention is a smoker device comprising the following: (a) a smoking chamber divided into a lower first sub-chamber and an upper second sub-chamber, wherein smoke can pass between the first sub-chamber and the second sub-chamber; (b) a firepot within the first sub-chamber that generates heat and the smoke; (c) an exhaust pipe located within the first sub-chamber and above the firepot, the exhaust pipe having at least one inlet and an outer end; and (d) an exhaust stack connected to the outer end of the exhaust pipe and extending upward. In this embodiment the smoking chamber is configured to force the smoke to follow a circulation path through the smoking chamber and then to enter the exhaust pipe through the exhaust pipe inlet and wherein the smoke is reheated by the firepot before leaving the smoker device. In this, or an alternate embodiment, the smoking chamber and the exhaust stack are configured to create a pressure differential between the pressure inside the smoking chamber and a pressure external to the smoker device and wherein the pressure inside the smoking chamber is less than the pressure external to the smoker device.

### BRIEF DESCRIPTION OF THE SEVERAL VIEWS OF THE DRAWINGS

To facilitate understanding of the invention, the drawings and description illustrate preferred embodiments thereof, from which the invention, various embodiments of its structures, construction and method of operation, and many advantages, may be understood and appreciated. The drawings are incorporated by reference.

FIG. 1A is a perspective view of one embodiment of a smoker device according to the present invention;

FIG. 1B is another view of the smoker device of FIG. 1A with the smoking chamber door partially open to show the inside of the smoking chamber;

FIG. 2 illustrates the movement of smoke within the smoking chamber of one embodiment of the present invention and illustrates the pressure and temperature variations within and external to the smoking chamber of this embodiment during use;

FIG. 3 shows the interior of one embodiment of a smoker device of the present invention;

FIG. 4A illustrates the movement of grease within the interior of one embodiment of a smoker device of the present invention;

FIG. 4B illustrates the interior of one embodiment of a smoker device according to the present invention;

FIG. 4C illustrates one embodiment of a damper according to the present invention, also shown in FIG. 4B;

FIG. 4D shows another embodiment of a smoker device of the present invention;

FIG. 5 show one embodiment of a standard hopper assembly;

FIG. 6 illustrates the flow of smoke through one embodiment of a smoker device of the present invention;

FIG. 7 illustrates one embodiment of a smoker device configured to utilize a venturi configuration in the exhaust assembly; and

FIG. 8 shows one embodiment of an offset smoker of the invention having a boosted exhaust air flow.

### DETAILED DESCRIPTION OF THE INVENTION

The following describes example embodiments in which the present invention may be practiced. This invention, however, may be embodied in many ways, and the descriptions provided should not be construed as limiting. The following invention may be embodied as methods, systems, or devices. These detailed descriptions should not be taken in a limiting sense. The accompanying drawings are hereby incorporated by reference.

In this document, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. All publications, patents, and patent documents referred to in this document are incorporated by reference herein in their entirety, as though individually incorporated by reference. If inconsistent usages occur between this document and those documents so incorporated by reference, the usage in the incorporated reference(s) should be considered supplementary to that of this document; for irreconcilable inconsistencies, the usage in this document controls.

While the disclosure has been described in detail and referring to specific embodiments thereof, it will be apparent to one skilled in the art that various changes and modifications can be made without departing from the spirit and scope of the embodiments. Thus, it is intended that the present disclosure covers the modifications and variations of this disclosure provided they come within the scope of the appended claims and their equivalents.

For the description, the terms “upper”, “lower”, “right”, “left”, “vertical”, “horizontal”, “top”, “bottom”, “lateral”, “longitudinal”, and derivatives thereof shall relate to the invention as it is oriented in the figures. However, it is to be understood that the invention may assume alternative variations and step sequences, unless specified to the contrary. It also is to be understood that the specific devices and processes illustrated in the attached drawings and described in this specification are simply exemplary embodiments of the invention. Hence, specific dimensions and other physical characteristics related to the embodiments disclosed are not to be limiting.

This application is a Continuation-in-Part application claiming priority to U.S. Nonprovisional application Ser. No. 18/206,879, filed Jun. 7, 2023, which claims the benefit under 35 U.S.C. § 119 to U.S. Provisional Application Ser. No. 63/349,810, filed Jun. 7, 2022, each of which is incorporated by reference herein in its entirety. To the extent that portions of this application build upon some of the ideas disclosed in Nonprovisional application Ser. No. 18/206,879 that Application can be referred to for additional background information and explanation.

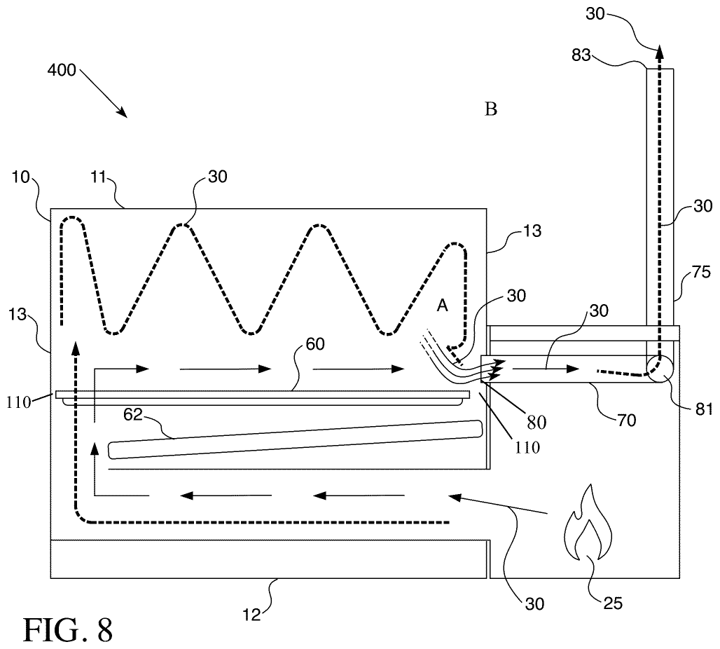

Overview of Parts and Configurations of Smoker Devices 1. The present invention encompasses a variety of smoker devices 1 in the category of pellet cookers, barbeques, smokers, offset smokers, grills, and hybrid smoker-grills. The inventions described herein can be used as, incorporated into, and modified for use with pellet cookers, barbeques, smokers, offset smokers, grills, and hybrid smoker-grills. For case of discussion herein, all such devices and analogous devices are referred to collectively as a “smoker device 1.” Additionally, while the primary embodiments are described as using “fuel 40,” various embodiments of this invention are adaptable for use with different types of combustible fuel including but not limited to pellets, wood, charcoal, propane, and natural gas. The type of fuel 40 used depends upon the design and purpose of the individual smoker device 1. Additionally, the phrase “smoking chamber 10” includes a chamber in which food is heated, smoked, cooked, or any combination thereof regardless of whether that chamber 10 is divided into sub-chambers or undivided. Some embodiments of a smoker device 1 of the present invention that utilize pellets 40 as a type of fuel 40 comprise two primary structures: (1) a smoking chamber 10, and (2) a pellet hopper assembly 200. Other embodiments are configured to work without pellets and, therefore, do not need a pellet hopper assembly 200 (see FIG. 8 for one example of a smoker that can be used without pellets).

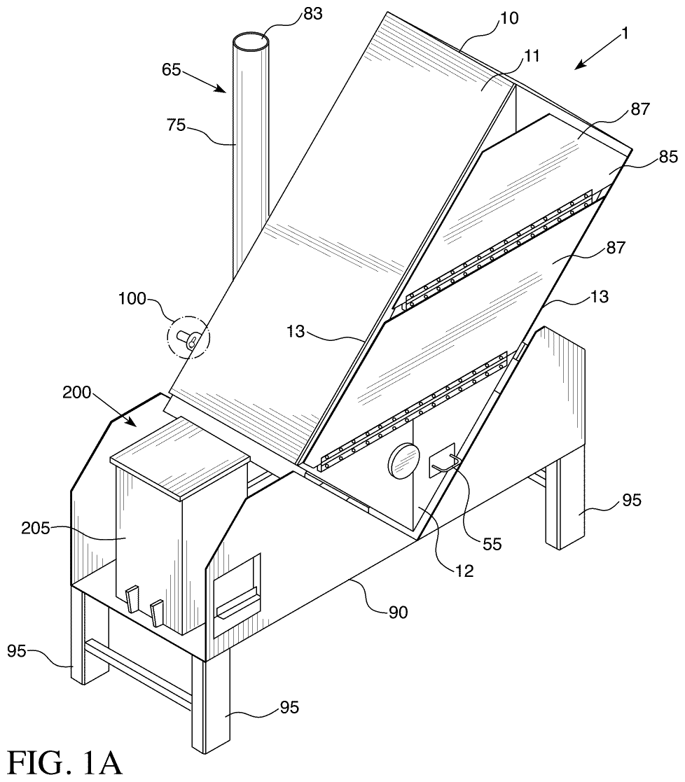

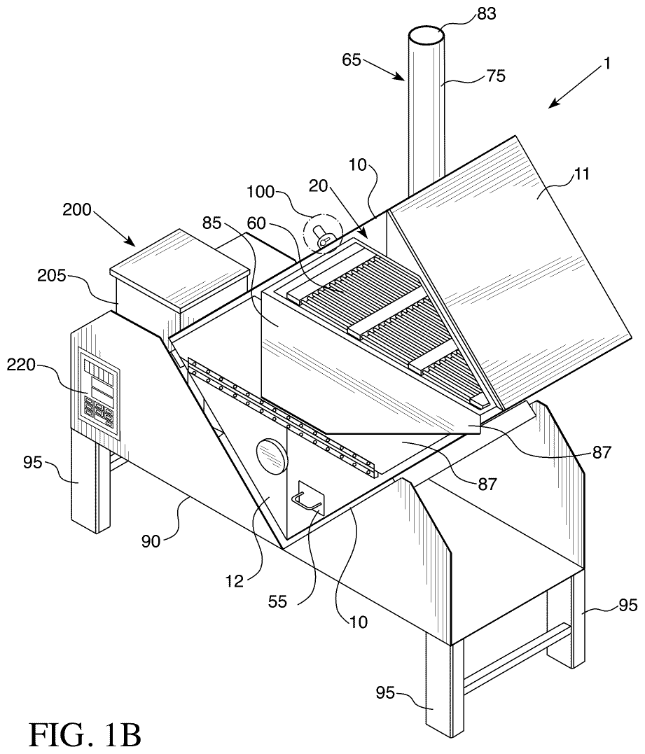

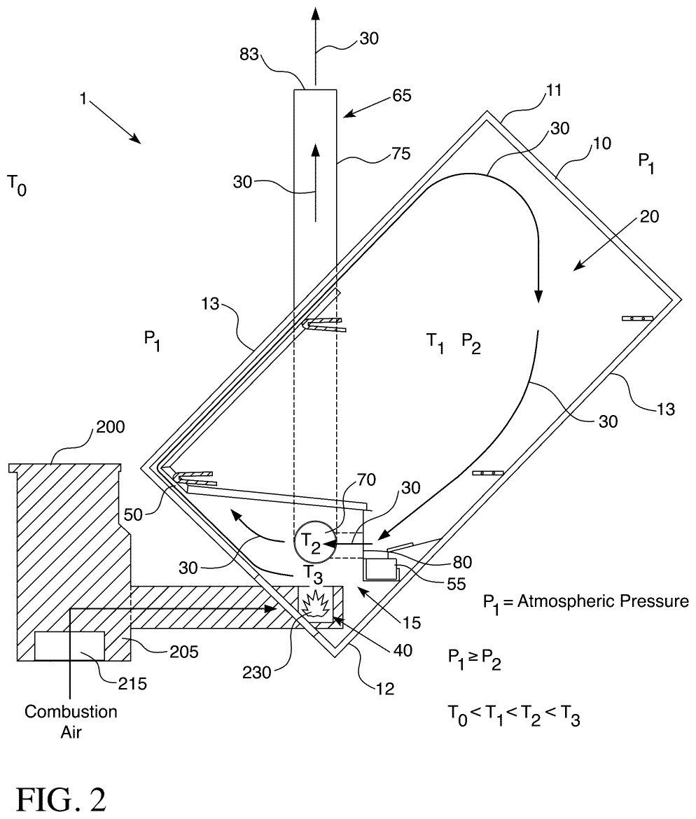

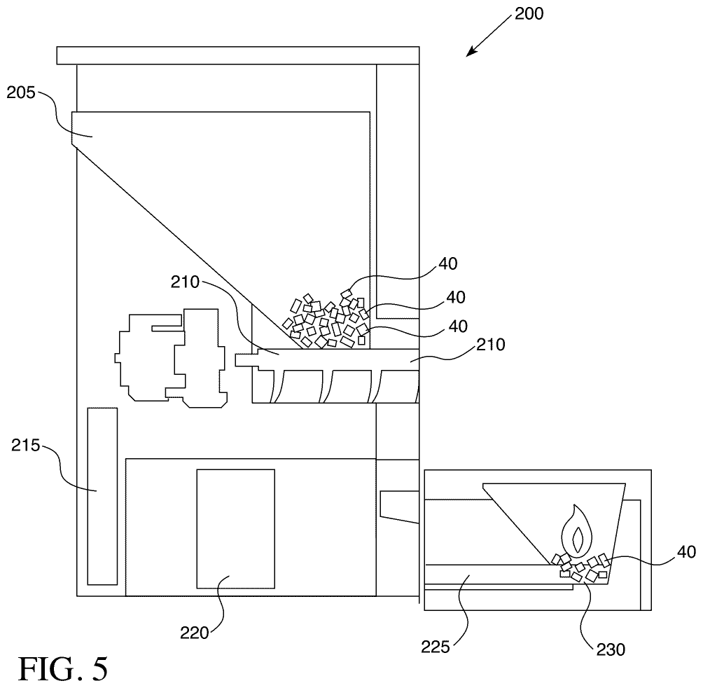

The hopper assembly 200 of some embodiments of the present invention is separate from and slidably connected adjacent to one side of the smoking chamber 10 (see FIGS. 1A, 1B, and 2). The construction of the hopper assembly 200 of some embodiments of the present invention is similar to any standard assembly 200 available in this technology field (see FIG. 5 for one non-limiting example of a standard hopper assembly 200). Hopper assemblies 200 usually are designed as a box made of stainless steel or a similar strong and heatproof material. Inside a standard self-feeding hopper assembly 200 is a hopper 205 (which holds the unheated fuel 40), a firepot 230 (in which the fuel 40 burns), an auger 210 (which moves the fuel 40 from the hopper 205 to the firepot 230), a fan 215 can be incorporated to circulate air for combustion, and an igniter 225 (to ignite the fuel 40). Most versions of hopper assemblies 200 for use with the present invention do not have an integral firepot 230. Instead, the hopper assemblies 200 feed fuel 40 to a firepot 230 that is integral to the smoker device 1. Alternative embodiments of the present invention do not use a hopper assembly 200 and, instead, the user puts the fuel 40 into a firebox 25, which houses the firepot 230. The firebox 25 for these configurations is integral to the smoker device 1 and, for some embodiments, integral to the smoking chamber 10.

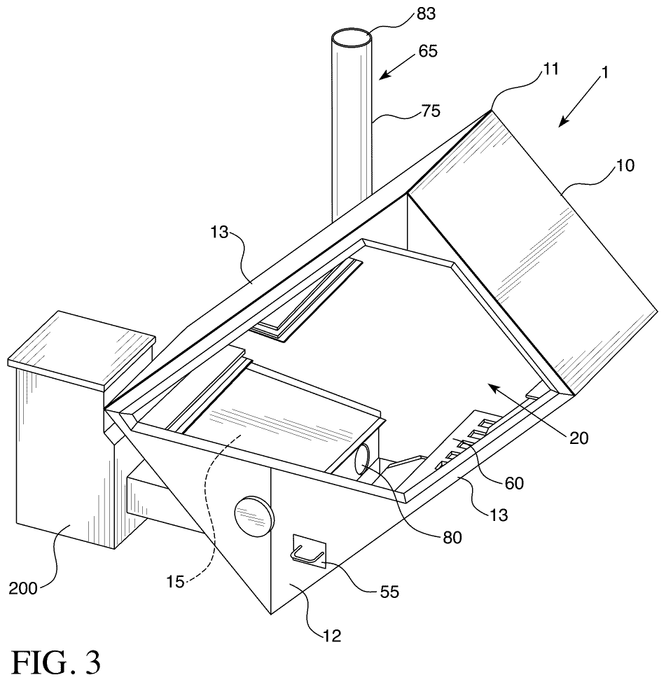

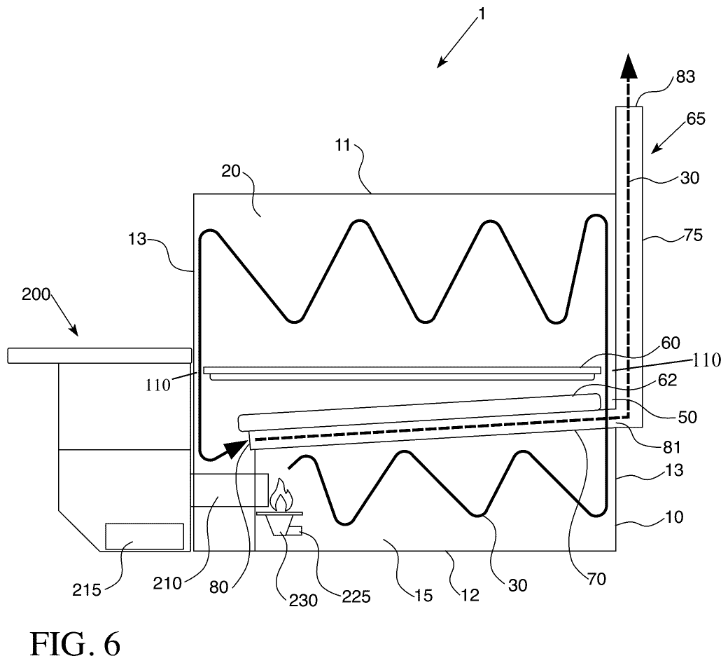

Various exemplary (but non-limiting) embodiments of smoker devices 1 of the present invention are illustrated in FIGS. 1A through 4D and FIGS. 6 through 8. FIGS. 1A through 4D show embodiments of a smoker device 1 having a diamond-shaped or oriented smoking chamber 10 and FIGS. 6 through 8 show three embodiments having a horizontal or rectangular-shaped smoking chamber 10. The following elements of various embodiments of smoker devices 1 of the present invention can be incorporated into smoking chambers 10 having a variety of shapes and orientations. These elements include a smoker device 1 and smoking chamber 10 configured so that: (1) all smoke, circulating heated air, and other combustion gasses (collectively “smoke 30”) generated by the burning of fuel 40 are directed to follow a circulation path over the cooking surface 60 and then enter the exhaust pipe 70 through inlet 80; (2) at least a portion of an exhaust pipe 70 is located over the burner/heat source/firepot 230 so that the smoke 30 is reheated before leaving smoking chamber 10 and discharging outside of smoker device 1; (3) smoke 30 is reheated in the exhaust pipe 70 whereby the draft is increased; and (4) the smoking chamber 10 operates at a pressure differential in which the internal pressure (P₂) is less than or equal to the pressure (P₁) external to the smoking chamber 10 at the location of the specific smoker device 1. This pressure differential may be applied by mechanical means such as an exhaust fan 215, venturi 300 (also referred to herein as a venturi configuration 300), by the draft of the exhaust chimney or exhaust assemblies 65, or by configuration of the smoking chamber 10.

The smoker devices shown in FIGS. 1A through 4D and FIGS. 6 through 8 have a smoking chamber 10 having a top 11, a bottom 12, and (depending upon the shape) at least one side 13. Some embodiments, such as those shown in FIGS. 1A, 1B, 2, 4A-4D, 6 and 7 have a chamber 10 that is divided into at least two sub-chambers 15 and 20. The at least one side 13 connects to the top 11 and the bottom 12 to enclose the smoking chamber 10. In one embodiment of the present invention (shown in FIGS. 1A through 4D), the smoking chamber 10 has a diagonal longitudinal axis with an upper section and a lower section, but alternative variations are included within the scope of this invention including an essentially vertical longitudinal axis (shown in FIGS. 6 through 8) and alternative embodiments having a longitudinal axis of chamber 10 at varying angles and orientations. For some embodiments of the present invention, the smoking chamber 10 is divided into a first sub-chamber 15 that is oriented at least partially below the second sub-chamber 20. For these divided embodiments, the first sub-chamber 15 is located in the lower section of the smoking chamber 10 and a second sub-chamber 20 is located in the upper section of the smoking chamber 10, which contains the cooking surface 60 (usually grates 60). For the embodiments illustrated in FIGS. 1A through 4D and 6 through 7, the first sub-chamber 15 contains the firepot 230. For an offset smoker 400, an example of which is illustrated in FIG. 8, the firepot 230 is located within an adjacent firebox 25 (often laterally or horizontally adjacent to the smoking chamber 10). For some embodiments, the smoking chamber 10 is essentially one chamber (equivalent to the second sub-chamber 20) and the firepot 230 is outside and adjacent to the smoking chamber 10 (FIG. 8).

Referring to FIG. 2, the first sub-chamber 15 encompasses the location of the burning fuel 40 and the firepot 230 and is where the smoke 30 and heat 30 are produced. The second sub-chamber 20 is where the food is located for heating, cooking, and smoking. As shown in FIG. 2, the first sub-chamber 15 in this depicted embodiment, is open to the second sub-chamber 20 above and to the left of the firepot 230, via a chase 50, so that smoke 30 circulates around the inside of chamber 10 and does not reenter sub-chamber 15. Instead, it is drawn into inlet 80. The location of inlet 80 can change in other embodiments and, for example, be located to the right of firepot 230 as shown in FIG. 2 (or opposite and distant from hopper assembly 200). In one embodiment, inlet 80 has a predetermined size that is sufficient to facilitate a pressure differential as between the inside of the smoking chamber 10 and the outside or ambient environment. As a result of this arrangement, the smoke 30 that circulates through the second sub-chamber 20 enters the exhaust assembly 65 through the exhaust pipe inlet(s) 80, but essentially does not remix with the smoke 30 in the first sub-chamber 15. This system of chambers forces the heat and smoke 30 to follow a specific path from the first sub-chamber 15 through second sub-chamber 20 (cooking, smoking, and heating chamber) before entering the exhaust system through inlet 80 where it is reheated, thus, increasing the draft before leaving the smoking chamber 10 and being discharged to the outside.

In some embodiments of the present invention, the smoking chamber 10 is adjacent to and removably connected to the hopper assembly 200 (see FIGS. 1A to 4D). When these embodiments are in use, the firepot 230 sits within the smoking chamber 10, and specifically within the first sub-chamber 15. FIG. 5 illustrates a standard hopper assembly 200. As shown in FIG. 2, the smoking chamber 10 of one embodiment of the present invention comprises two sub-chambers 15 and 20. The first sub-chamber 15 encompasses the firepot 230 and the burning fuel 40, which create the smoke 30. As used herein, the term “smoke 30” generally refers to the heated smoke, air, combustion gasses, and any other gasses that circulate throughout the smoking chamber 10. The second sub-chamber 20 is the chamber in which the food is heated, smoked, or cooked. FIG. 8 illustrates an offset smoker 400 wherein the firepot 230 is separate from and adjacent to the smoking chamber 10 in a fire box 25.

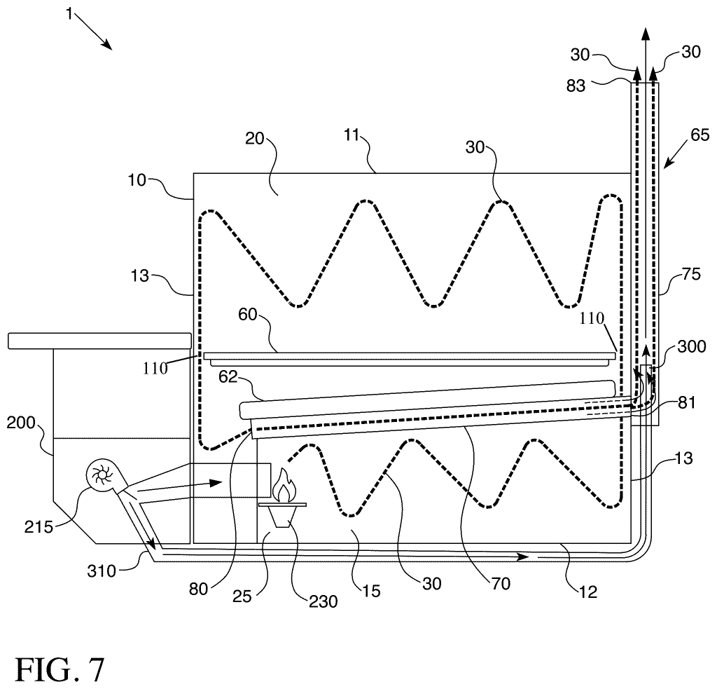

An exhaust assembly 65 vents the smoke 30 that has circulated through the smoking chamber 10. For most embodiments of the present invention, the exhaust assembly 65 comprises an exhaust pipe 70, an exhaust stack 75, at least one exhaust pipe inlet 80, and an exhaust stack outlet 83. In most embodiments of the present invention, the exhaust pipe 70 runs substantially horizontally with an orientation transverse to the longitudinal axis of the smoking chamber 10 and some portion of the exhaust pipe 70 is located directly above the firepot 230. The exhaust pipe 70 has at least one inlet 80 and an outer end 81 extending at least to the end of, and in some arrangements out of, the smoking chamber 10 (most clearly seen in FIGS. 6 and 7). The exhaust pipe's outer end 81 connects to, or becomes, the exhaust stack 75, which runs essentially vertically, usually along the exterior of the smoking chamber 10, as shown in FIGS. 1A to 4B, 4D, and 6 through 8. In one alternative embodiment, the exhaust stack 75 can run vertically through the interior of the smoking chamber 10. The geometry and orientation of exhaust pipe 70 and exhaust assembly 65 can vary and are not limited to the embodiments shown in the Figures. The exhaust stack 75 extends upward to vent the smoke 30 from the smoking chamber 10. For some embodiments of the present invention, the smoke 30 originates in the first sub-chamber 15, moves through a chase 50 (or another opening 110 between the chambers 15, 20) and into the second sub-chamber 20. The smoke 30 circulates through the second sub-chamber 20 as shown in FIGS. 2, 6 and 7 then enters the one or more exhaust pipe inlets 80 and moves into the exhaust pipe 70. In some embodiments, the smoke 30 travels along the exhaust pipe 70, which runs through the first sub-chamber 15, to the exhaust stack 75 and exits the exhaust stack 75 at its outlet 83. For some embodiments of the present invention, the exhaust pipes 70 run more or less horizontally through the first sub-chamber 15 and above the firepot 230. For some embodiments of the present invention, the outlet 83 of the exhaust stack 75 is the tallest or highest point of the smoker device 1. The exhaust pipe inlet 80 is one or a plurality of holes, tubes, or similar structures into which the smoke 30, that has circulated through the smoking chamber 10, enters the exhaust pipe 70. In some embodiments of the present invention, the exhaust pipe 70 originates over or is located directly over the firepot 230.

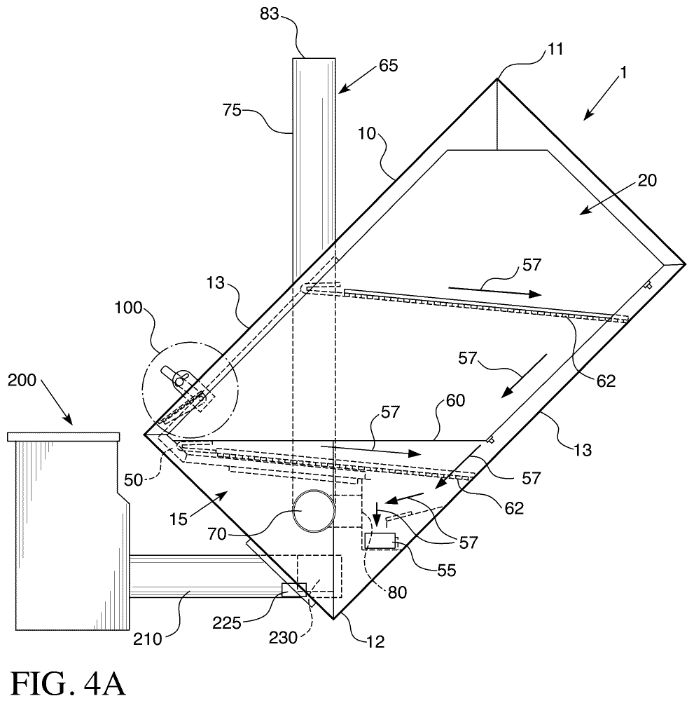

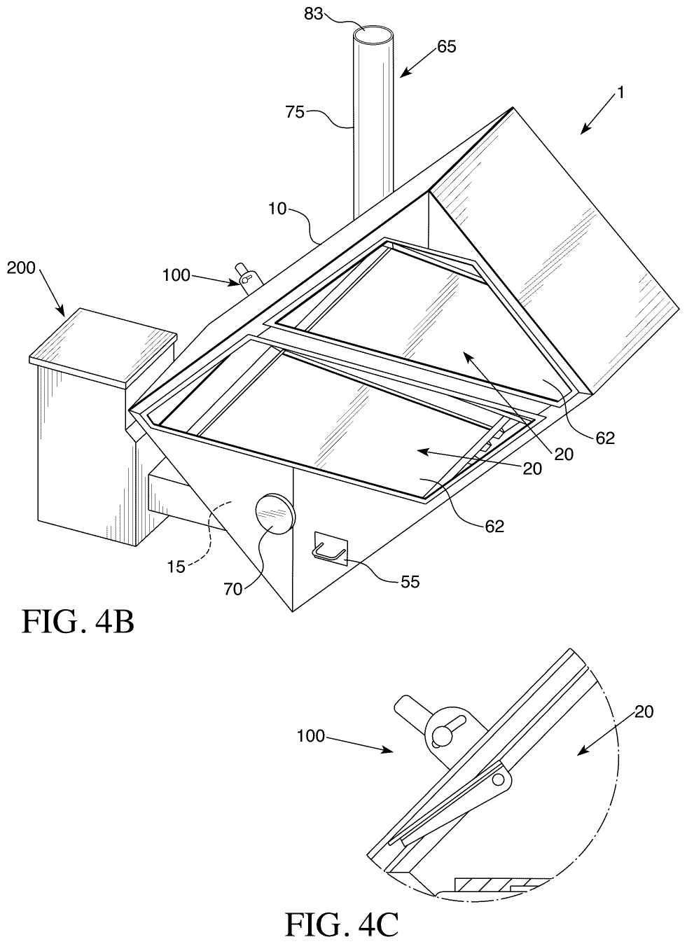

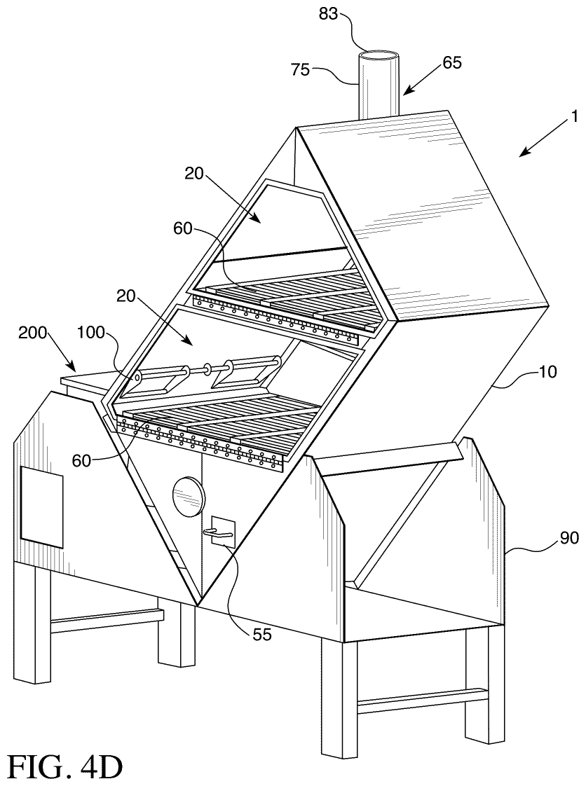

In some embodiments of the present invention, one or more (optionally slanted) drip pans 62 are located within the second sub-chamber 20 and can be configured to divide the second sub-chamber 20 into smaller smoking areas (while still having the smoke 30 able to move between the sub-chambers 15, 20 through one or more openings 110). In some embodiments, the drip pans 62 can be configured to control the flow of smoke 30 within the smaller smoking areas. Nonlimiting examples of drip pan 62 arrangements are shown in FIGS. 4A, 4B, and 6 through 8.

Grates 60 support the food in the smoking chamber 10. The one or more grates 60 are mounted in essentially level or horizontal positions and span the smoking chamber 10 as shown in FIGS. 1B, 4A, 4D, and 6 through 8. In most but not all embodiments where both drip pans 62 and grates 60 are used in the smoking chamber 10, the grates 60 sit above the drip pans 62. The grates 60 of the present invention can have a traditional grill or smoker grate structure or they can have a mostly solid surface with small holes or perforations through which the grease 57 drips. Grates 60 of a variety of structures, materials, and designs work with the present invention and different styles of grates 60 can be used for different types of cooking techniques, different foods, or different smoker device 1 designs. All such variations of grates 60 are included within the scope of the present invention.

In one embodiment of the present invention, the combination of the smoking chamber 10 and the hopper assembly 200 is supported by a table-like support structure 90 with legs 95 as illustrated in FIGS. 1A and 1B. The support structure 90 can have wheels, be mobile, or be stationary. The hopper assembly 200 and/or smoking chamber 10 can be permanently or removable connected to the support structure 90.

Within the context of smoker devices 1 generally described above, the present invention also comprises various embodiments of the following: (1) a smoker device 1 that is an offset smoker 400 configured to reheat the smoke 30 in the exhaust assembly 65 (FIG. 8); and (2) a smoker device 1 configured to increase the flow of smoke 30 through the device 1 by incorporating a fan 215 and/or venturi 300 into the exhaust assembly 65 (FIG. 7).

Offset Smoker 400 Configuration. Many of the novel configurations and designs of smoker devices 1 described previously herein can be incorporated into offset smoker devices 400 to achieve many of the same advantages. One non-limiting example of an offset smoker device 400 is show in FIG. 8. In general, an offset smoker device 400 is a smoker or grill with an adjacent firebox 25 containing a firepot 230 and/or configured to burn wood and charcoal (where the fire box 25 is adjacent to but outside of the smoking chamber 10). This is in contrast to a smoker device 400 in which the firebox 25 is within the smoking chamber 10, as illustrated in FIGS. 2 through 4B, 4D, 6, and 7. Within the context of the offset smoker configurations 400 of the present invention, the term “firepot 230” merely means the location of fuel 40 combustion in the firebox 25, which (for an offset smoker 400) is located outside of the smoking chamber 10 (see FIG. 8.) Most embodiments of an offset smoker 400 have a separate fire box 25 in which the fuel 40 burns. The smoke 30 travels through the cooking chamber 10 and then is reheated by the fire in the fire box 25 thus increasing the smoke's temperature, reducing its density, and boosting the draft in the exhaust assembly 65 (see FIG. 8).

One embodiment of an offset smoker device 400 according to the present invention has a smoking chamber 10 and a firebox 25 containing a firepot 230 laterally adjacent to and connected to the smoking chamber 10 (see FIG. 8). An exhaust pipe 70 is located above the firepot 230. The exhaust pipe 70 has two, opposing ends, namely, an inlet 80 that connects to the smoking chamber 10 and an outer end 81 that connects to an exhaust stack 75. The exhaust stack 75 extends upwards from the offset smoker device 400. In this embodiment, the firepot 230 heats the exhaust pipe 70 during operation of the offset smoker device 400 creating a pressure differential between the pressure within the smoking chamber 10 (FIG. 8 at A) and the pressure outside of the smoker device 400 (FIG. 8 at B).

For various embodiments of an offset smoker device 400 of the present invention, the firebox 25 is configured to create smoke 30 that enters the smoking chamber 10. The pressure differential helps to pull the smoke 30 through the smoking chamber 10 (illustrated by the arrows in FIG. 8 moving from the interior of the smoking chamber 10, through the inlet 80, and into the exhaust pipe 70.)

Some embodiments of the present invention can incorporate a venturi 300 or venturi configuration 300 in the exhaust stack 75 or exhaust pipe 70 to achieve additional advantages. The incorporation of a venturi 300 is described in more detail in the section that follows.

According to the present invention, various embodiments of an offset smoker device 400 are configured such that: (1) all or most of the smoke 30 is directed to follow a circulation path through the smoking chamber 10 and then enter the exhaust pipe 70 through inlet 80; (2) at least some portion of the exhaust pipe 70 is located over the burner/heat source/firepot 230 and within the firebox 25 so that the exhaust smoke 30 is reheated before leaving the offset smoker 400; and (3) the smoking chamber 10 operates at pressure differential wherein the pressure within the smoking chamber 10 (FIG. 8 at A) is less than or equal to the external pressure at the location of the smoker device 1 in question (FIG. 8 at B). When configuring an offset smoker device 400 according to the present invention, the exhaust pipe 70 runs through the firebox 25 and reheats the exhaust (smoke 30) within the exhaust assembly 65, thus increasing the draft/flow of the smoke 30.

Incorporating a Venturi 300 into the Exhaust Assembly 65 and Other Configurations to Achieve a Pressure Differential. As explained above, various embodiments of smoker devices 1 according to the present invention operate at a pressure differential in which the pressure inside the smoking chamber 10 is less than the pressure outside the smoking device 1 at the location of the device 1 in question (see FIGS. 2 and 8). The pressure differential can be created by mechanical means (e.g., an exhaust fan 215 or venturi 300) or, alternately or additionally, by heating the draft in the exhaust assembly 65. In general, though, the various embodiments of smoker devices 1 of the present invention incorporate the structures and configurations necessary to increase the flow of smoke 30 in the exhaust stack 75 by one or more of the following five methods

First, configuring the smoker device 1 so that the smoke 30, after circulating through the smoking chamber 10, is exposed to a heat source (one example is the firepot 230, as shown in FIGS. 2, 4A, and 6-8) before or as the smoke 30 enters the exhaust stack 75. This heating of the exhaust smoke 30 prior to it traveling up the exhaust stack 75 increases the temperature of the smoke 30, lowers its density, and creates a higher draft, which results in lower pressure in the cooking chamber 10 (see FIGS. 2 and 8). This increases the draft in the exhaust stack 75, resulting in lower back pressure (in some embodiments approaching a vacuum, shown as “A” in FIG. 8 and in FIG. 2 generally) in the cooking chamber 10.

Second, using a venturi 300 of a conventional design in the exhaust assembly 65, which reduces the pressure in the cooking chamber 10 (approaching and, in some embodiments, even reaching pressures below atmospheric). This mechanism benefits from a motive fluid which is provided by a fan or blower 215 (see FIG. 7). The terms “venturi 300” and “venturi configuration 300” as used interchangeably herein encompass any parts and configurations to implement the Venturi Effect in the exhaust assembly 65 of a smoker device 1 of the present invention.

Third, creating low pressure within the cooking chamber 10 using the Coanda Effect by structuring the cooking chamber 10 and/or the exhaust stack 75 to utilize the tendency of fluid (or smoke 30) flow to stay attached to a convex surface.

Fourth, utilizing the concept of “entrainment”. This is the geometry shown in FIG. 6 and does not need a restriction in the exhaust stack 75 because of the design of the smoking chamber 10 and the exhaust assembly 65. As shown in FIG. 6, the smoke 30 enters the second sub-chamber 20 at one side through at least one opening 110 and is forced to circulate within the sub-chamber 20 before it can exit at the opposite side of the sub-chamber 20 through a different at least one opening 110. The smoke 30 is trapped within the sub-chamber 20 until it finds the pathway to the exhaust pipe inlet 80. This embodiment has the advantages of being practical and relatively inexpensive because it requires few, if any, additional parts to achieve the benefits.

Fifth, incorporating a fan 215 into the exhaust assembly 65. This works to increase the flow in the exhaust stack 75 (see FIG. 7).

All the options detailed above facilitate reaching the goal of creating lower pressure inside the smoking chamber 10, as compared to the external pressure at the location of the smoker device 1 and manage the exhaust smoke 30 flow. Increasing the total flow of smoke 30 through the smoker device 1 is advantageous to the efficient operation of the smoker device 1. Lowering the pressure in the cooking chamber 20 also reduces leaks of smoke 30 from parts of the smoker device 1 other than the outlet 83.

One embodiment of the present invention configured to create this pressure differential is illustrated in FIG. 2. Other embodiments of the present invention incorporate the parts and processes for moving smoke 30 into the exhaust stack 75 of the smoker device 1 to create low pressure (via the Venturi Effect) in the firebox 25, which serves to increase control over the smoke 30 and the temperature within the smoker device 30 (see FIGS. 1A through 4D and 6 through 8). These configurations also further prevent smoke 30 leakage from areas other than the exhaust assembly 65 of the smoker device 1.

The Venturi Effect states that if airflow is constant through an area and the air passes through a smaller opening, constriction, or choke, then the speed of the air will increase. For example, if air is flowing through a pipe of consistent size and then the air encounters a constricted section, the speed of the air in the constricted area will be higher than it was in the un-constricted pipe. The “constriction” speeds up the airflow. For the purposes of this invention, this “constriction” is referred to as a “venturi 300”, which includes any structures and designs to narrow the passageway through which the air (smoke 30) is flowing. Various embodiments of the present invention incorporate a venturi 300 within the exhaust assembly 65 to increase the pull and flow of the smoke 30 through the smoker device 1.

FIG. 7 illustrates one exemplary embodiment of a smoker device 1 with a venturi 300 (a narrowing) in the exhaust assembly 65. Any method to increase the flow of smoke 30 in the exhaust stack 75 and reducing pressure in the cooking chamber 20 in a smoker device 1 as disclosed in the narrative and figures of this application is encompassed by the present invention.

As shown in FIG. 7, a venturi 300 is located toward the lower end of the exhaust stack 75, near the connection to the exhaust pipe 70. However, other locations within and along the exhaust pipe 70 and/or the exhaust stack 75 are included in the present invention. A venturi 300 can be a narrowing of the actual exhaust stack 75 or exhaust pipe 70 or it can be additional part(s) that are inserted into the exhaust stack 75 or exhaust pipe 70 to create a constriction or choke point. Another alternative is to configure the connection between he exhaust stack 75 and exhaust pipe 70 such that a venturi 300 is created by the exhaust stack 75 and the exhaust pipe 70 having different diameters. It will be obvious to one skilled in the art that there are numerous ways to create a venturi 300 in a pipe or tube structure.

Some embodiments of the present invention can incorporate a fan 215 that feeds air into the exhaust assembly 65 to increase the draft or pull of smoke 30 through the firebox 25 and smoking chamber 10 and into the exhaust stack 75. FIG. 7 shows one arrangement of a fan 215 (in this embodiment located in the hopper assembly 200) blowing air into the firebox 25 and into a boost pipe 310, which feeds directly into the exhaust stack 75. The incorporation of a venturi 300, with or without a fan 215 or other source of air flow feeding air into the firebox 25 and/or the exhaust stack 75, creates a pressure differential in the exhaust stack 75 near where it joins the exhaust pipe 70. This pressure differential pulls that smoke 30 through the horizontal exhaust pipe 70 and thereby increases the air and smoke 30 circulation within the smoking chamber 10, increases the airflow throughout the entire smoker device 1, and increases many of the gains and improvements detailed herein, including but not limited to, creating more consistent cooking temperatures and resulting in less smoke loss from other parts of the smoker device 1.

Numerous alternative embodiments of the present invention include all the variations of a smoker device 1 detailed in this specification and illustrated in FIGS. 1A through 8 with the additional components of (1) a venturi 300 located in the exhaust stack 75; and/or (2) a fan 215 forcing air into a boost pipe 310 that runs from the fan 215 to the exhaust stack 75; and/or (3) reheating the smoke 30 before it reaches the exhaust stack 75.

For embodiments similar to that illustrated in FIG. 7, which incorporate a fan 215 to blow air towards the firepot 230 and into a boost pipe 310, the fan 215 can be configured to control the amount of air entering into either location. It will be obvious to one skilled in the art to incorporate any of a wide variety of airflow adjustment mechanisms into the smoker device 1 or the pellet hopper assembly 200 to control whether the air from the fan 215 is going to the firepot 230, the boost pipe 310, or both.

In some embodiments of the present invention, as shown in FIGS. 2 and 8, the smoker devices 1 have exhaust pipes 70 running more or less horizontally through the smoking device 1. In some embodiments, the exhaust pipe 70 travels through the first sub-chamber 15, and is located directly above the firepot 230, with an exhaust inlet 80 positioned on a side of exhaust pipe 70 (FIG. 2) and the outlet 83 of the exhaust assembly 65 being the tallest or highest point of the smoker device 1. In alternative embodiments of the present invention, the exhaust inlet 80 can be located on the same side as the hopper assembly 200 or along any side of the exhaust pipe 70 as long as the smoke 30 is forced to travel around the second sub-chamber 20 before entering the inlet 80 and generally without remixing with smoke 30 and gasses first emitted in the first sub-chamber 15. In some embodiments, the exhaust pipe 70 runs horizontally through the firebox 25 and above the firepot 230. More specifically, because of its location, the exhaust pipe 70 and the smoke 30 pulled inside of it are being heated (or reheated) directly both by the radiant energy and convection from the firepot 230. The exhaust assembly 65 operates on the principle that hot air rises such that air, smoke and gasses heated by the fuel 40 in firepot 230 will rise up the exhaust stack 75 and out of chamber 10. The rising hot smoke 30 creates a pressure differential between the pressure P2 shown within chamber 10 in FIG. 2, and pressure PI outside of chamber 10 (and FIG. 8 at A and B). This pressure differential is known as the draft or pulling power of the chimney or exhaust assembly 65. This pressure differential and resulting draft or pulling power sucks smoke 30 into exhaust pipe 70 and exhaust stack 75.

In the embodiment of the invention shown in FIG. 2, there are four different temperatures noted. To is the ambient atmospheric temperature, or the temperature of the environment around the smoker device 1. T₁ is the temperature inside the second sub-chamber 20. T₂ is the temperature of the reheated smoke 30 in the exhaust pipe 70 above the firepot 230 (otherwise referred to the flue gas temperature). T₃ is the temperature at or immediately above the firepot 230 in the first sub-chamber 15. When the smoker device 1 is operating, the relative temperatures in one preferred embodiment are as follows: T₀<T₁<T₂<T₃. The hottest temperature T₃ of the smoke 30 in the smoking chamber 10 is directly above the burning pellets 40 in the firepot 230 and the second highest temperature is at T₂ inside exhaust pipe 70. In this embodiment, an ultimate net draft is created by the temperature (density) difference between the ambient air temp To and the flue gas temp T₂. The larger that difference, the more draft is created. However, in embodiments where there is a fan 215 pushing the combustion air into the smoking chamber 10, the draft must outpace the push from the fan 215, otherwise the smoker device 1 will operate at positive pressure. The reheating of the exhaust gas boosts the temperature difference between the ambient air temp T₀ and the flue gas temp T₂ and provides enough boost to stay ahead of the fan 215.

The resulting motion or convection current of air, gasses and smoke 30 is shown as having a clockwise direction in FIG. 2, with the convection current of air, gasses and smoke 30 starting above firepot 230, moving upward along the angled, straight or curved walls of chamber 10 facing toward or closest to hopper assembly 200 to sub-chamber 20 and then downward along the angled, straight or curved walls of chamber 10 facing and further away from hopper assembly 200, whereby the air, gasses and smoke 30 are pulled into the exhaust inlet 80, where they are reheated and drawn up exhaust stack 75. The design of the invention shown in FIG. 2, including (i) the relative positions of the firepot 230 and exhaust pipe 70, the location of the exhaust inlet 80, and (iii) the angled orientation of the sides of chamber 10 in some embodiments operates to circulate the smoke 30 within chamber 10 in an improved manner to add smoked flavor to the food being cooked or smoked.

FIG. 6 shows a similar but opposite arrangement wherein the motion or convection current of air, gasses and smoke 30 is shown as having a counter-clockwise direction with the convection current of air, gasses and smoke 30 starting above firepot 230, moving towards the chase 50 that connects the first sub-chamber 15 and the second sub-chamber 20, then upward along the angled, straight or curved walls of chamber 10 on the side opposite the hopper assembly 200 into the second sub-chamber 20, around and towards the opposite wall (closest to the hopper assembly 200) and then downward along the angled, straight or curved walls of chamber 10 facing whereby the air, gasses and smoke 30 are pulled into the exhaust inlet 80. The movement of smoke 30 between the sub-chambers 15, 20 is facilitates by openings 110 on opposing sides of the smoking chamber 10. Once in the exhaust pipe 70, the air, gasses and smoke 30 is reheated and drawn up exhaust stack 75. The design of the invention shown in FIG. 6, including (i) the relative positions of the firepot 230 and exhaust pipe 70, and (ii) the location of the exhaust inlet 80 operates to circulate the smoke 30 within chamber 10 in an improved manner to add smoked flavor to the food being cooked or smoked. This circulation of smoke 30 substantially improves temperature control and consistency in cooking sub-chamber 20.

The circulation of the smoke 30 is illustrated in FIG. 2 along with relative variations in pressure and temperature within the different areas of the smoker device 1. Research on the operations of the present invention indicates that the second sub-chamber 20 operates at a pressure differential compared to the pressure outside the smoker 1, which results in significantly less smoke 30 exiting the device 1 anywhere other than through the exhaust stack 75 as compared to most other smokers 1 currently available. The smoke 30 circulation that results from this design has many benefits, which establish the present invention as superior to many smokers in the field. First, the smoke 30 circulation pattern eliminates the need for any fan in the smoking chamber 10 to circulate the smoke 30, which is needed in some commercial devices to move the smoke 30 throughout the smoking chamber 10. Second, the circulation pulls most of the smoke 30 efficiently through the smoker device 1 and out through the exhaust stack 75 without significant smoke 30 leaking out of other parts or areas of the smoker device 1. The design of many traditional smokers and hybrid smoker-grills locates the exhaust stack on the top of the device so that the smoke 30 travels up through device but does not circulate through the cooking chamber. The smoker device 1 of the present invention is configured to encourage the smoke 30 to circulate throughout the smoking chamber 10, which results in more flavorful food and a more consistent temperature and smoking environment. As such, the improved circulation of the present invention is more effective and efficient than existing smoker technologies. Preferred embodiments of a smoker device 1 of the present invention will have the seams, connection points, junctures, and other connection points sealed wherever possible to avoid having the smoke 30 escape the smoker device 1 from anywhere other than the outlet 83 until the smoker device 1 is fully heated and running. Sealing any holes, seams, etc. to avoid the loss of smoke 30 is not novel in this field. However, most existing technologies still have significant smoke 30 loss from areas of the smoker that are not the exhaust stack even with traditional sealing. The design of the smoker device 1 of the present invention, including the highly efficient draft and pull of smoke 30 through the smoking chamber 10, minimizes the loss of smoke 30 from anywhere other than the outlet 83 to a degree not seen by other technology in this field. Unlike most other smokers and hybrid smokers sold to this point, almost no smoke 30 escapes the smoker device 1 of the present invention from any location other than the outlet 83.

While the disclosure has been described in detail and with reference to specific embodiments thereof, it will be apparent to one skilled in the art that various changes and modifications can be made thereto without departing from the spirit and scope of the embodiments. Thus, it is intended that this application covers modifications and variations of this disclosure provided they come within the scope of the appended claims and their equivalents.

1. An offset smoker device comprising:
a smoking chamber;
a firebox adjacent to and connected to the smoking chamber;
a firepot located within the firebox;
an exhaust pipe, having an inlet and an outer end, wherein the exhaust pipe connects to the smoking chamber at or near the exhaust pipe inlet and wherein at least a portion of the exhaust pipe is located inside of the firebox; and
an exhaust stack connected to the outer end of the exhaust pipe and extending upward,
wherein the firepot heats the exhaust pipe during operation of the smoker device.

2. The offset smoker device of claim 1, wherein the exhaust pipe is located above the firepot.

3. The offset smoker device of claim 1, further comprising a venturi configuration in the exhaust stack.

4. The offset smoker device of claim 1, further comprising a venturi configuration in the exhaust pipe.

5. The offset smoker of claim 1, further comprising a cooking surface located within the smoking chamber that divides the smoking chamber into a first sub-chamber beneath the cooking surface and a second sub-chamber above the first sub-chamber.

6. The offset smoker of claim 5, wherein the firebox connects to the first sub-chamber and wherein the exhaust pipe connects to the second sub-chamber.

7. A smoker device comprising:
a smoking chamber;
a firepot within the smoking chamber;
an exhaust pipe located within the smoking chamber and above the firepot, the exhaust pipe having at least one inlet and an outer end;
an exhaust stack connected to the outer end of the exhaust pipe and extending upward; and
a venturi located within the exhaust stack.

8. The smoker device of claim 7, wherein the smoking chamber is divided into a first sub-chamber that houses the firepot and at least a portion of the exhaust pipe and a second sub-chamber configured to receive food and wherein the first sub-chamber is oriented at least partially below the second sub-chamber.

9. The smoker device of claim 8, wherein smoke generated by the firepot located in the first sub-chamber is directed, through configuration of the smoker device, to enter the second sub-chamber, then to follow a circulation path across the cooking surface, and then enter the exhaust pipe in the first sub-chamber.

10. A smoker device for smoking or cooking food comprising:
a smoking chamber divided into a lower first sub-chamber and an upper second sub-chamber, wherein the first sub-chamber is oriented at least partially below the second sub-chamber;
a firepot within the first sub-chamber;
an exhaust assembly comprising an exhaust pipe having at least one inlet and an outer end and an exhaust stack connected to the outer end of the exhaust pipe and extending upward; and
a venturi located within the exhaust pipe.

11. A smoker device comprising:
a smoking chamber divided into a lower first sub-chamber and an upper second sub-chamber, wherein the first sub-chamber is oriented at least partially below the second sub-chamber;
a firepot within the lower first sub-chamber to heat smoke;
a cooking surface in the upper second sub-chamber;
an exhaust assembly comprising an exhaust pipe having at least one inlet and an outer end and an exhaust stack connected to the outer end of the exhaust pipe and extending upward, wherein the exhaust pipe is located within the first sub-chamber above the firepot; and
a venturi located within the exhaust assembly,
wherein the smoking chamber is configured to create a circulation path for the smoke to move from the lower first sub-chamber, across the cooking surface in the second sub-chamber, back into the first sub-chamber, and into the exhaust pipe inlet.

12. The smoker device of claim 11, further comprising:
a fan adjacent to the smoking chamber; and
a boost pipe configured to extend between the fan and the exhaust stack to carry air from the fan to the exhaust stack near where the exhaust stack connects to the exhaust pipe.

13. The smoker device of claim 12, further comprising an airflow adjustment mechanism to control the flow of air into the boost pipe and the first sub-chamber.

14. A smoker device comprising:
a smoking chamber divided into a lower first sub-chamber and an upper second sub-chamber, wherein smoke can pass between the first sub-chamber and the second sub-chamber;
a firepot within the first sub-chamber that generates heat and the smoke;
an exhaust pipe located within the first sub-chamber and above the firepot, the exhaust pipe having at least one inlet and an outer end; and
an exhaust stack connected to the outer end of the exhaust pipe and extending upward;
wherein the smoking chamber is configured to force the smoke to follow a circulation path through the smoking chamber and then to enter the exhaust pipe through the inlet and wherein the smoke is reheated by the firepot before leaving the smoker device.

15. The smoker device of claim 14, wherein the smoking chamber and the exhaust stack are configured to create a pressure differential between the pressure inside the smoking chamber and a pressure external to the smoker device and wherein the pressure inside the smoking chamber is less than the pressure external to the smoker device.
